(19) United States
(12) Patent Application Publication
(10) Pub. No.: US 2007/0016605 A1
(43) Pub. Date: Jan. 18, 2007

(54) Mechanism for computing structural summaries of XML document collections in a database system

(76) Inventors: Ravi Murthy, Fremont, CA (US); Sivasankaran Chandrasekar, Palo Alto, CA (US); Eric Sedlar, San Francisco, CA (US); Nipun Agarwal, Santa Clara, CA (US)

Correspondence Address: HICKMAN PALERMO TRUONG & BECKER/ORACLE, 2055 GATEWAY PLACE, SUITE 550, SAN JOSE, CA, 95110-1089, US

(21) Appl. No.: 11/184,302

(22) Filed: Jul. 18, 2005

(51) Int. Cl. G06F 7/00

(52) U.S. Cl. 707/102

(57) ABSTRACT

A “structural summary” of a collection of XML documents is generated. The structural summary is a skeleton tree that represents all parent-child relationships found in a XML document collection.

### RELATED APPLICATION

This application is related to U.S. application Ser. No. 10/884,311, (Attorney Docket No. 50277-2512) entitled Index For Accessing XML Data, filed on Jul. 2, 2004 by Sivasankaran Chandrasekara, the contents of which are herein incorporated by reference in their entirety for all purposes.

### FIELD OF THE INVENTION

The present invention relates to processing XML data, and in particular, processing XML related operations on XML data.

### BACKGROUND OF THE INVENTION

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

The Extensible Markup Language (XML) is the standard for data and documents that is finding wide acceptance in the computer industry. XML describes and provides structure to a body of data, such as a file or data packet. The XML standard provides for tags that delimit sections of a XML entity referred to as XML elements. The following XML document A is provided to illustrate XML.

XML document A

```
<a c=“foo”>
    <b>5</b>
    <d>10</d>
</a>
```

XML elements are delimited by a start tag and a corresponding end tag. For example, segment A contains the start tag <b> and the end tag </b> to delimit an element. The data between the elements is referred to as the element's content.

An element has a name and is referred to herein by its name. The name of the element delimited by <b> and the end tag </b> is b and is thus referred to herein as element b or just b.

An element's content may include the elements value, one or more attributes and one or more elements. Element a contains two elements b and d. An element that is contained by another element is referred to as a descendant of that element. Thus, elements b and d are descendants of element a. An element's attributes are also referred to as being contained by the element.

An attribute is a name value pair. Element a has attribute c, which has the value ‘foo’.

Element b has the value 5 and element d has the value 10. Element a does not have a value.

By defining elements that contain attributes and descendant elements, a XML document defines a hierarchical tree relationship between the elements, descendant elements, and attributes of the elements.

Node Tree Model

XML documents are represented as a hierarchy of nodes that reflects the XML document's hierarhical nature. A hierarchy of nodes is composed of nodes at multiple levels. The nodes at each level are each linked to one or more nodes at a different level. Each node at a level below the top level is a child node of one or more of the parent nodes at the level above. Nodes at the same level are sibling nodes.

In a tree hierarchy or node tree, each child node has only one parent node, but a parent node may have multiple child nodes. A node that has no parent node linked to it is the root node, and a node that has no child nodes linked to it is a leaf node. A tree hierarchy has a single root node. In a node tree that represents a XML document, a node can correspond to an element, and the child nodes of the node correspond to an attribute or another element contained in the element.

For convenience of expression, an element and attribute of a XML document are referred to as the node that corresponds to that element or attribute within the node tree that represents the XML document. Thus, referring to 5 as the value of node b is just a way of expressing that the value of the element b is 5.

XML Storage on Database Systems

Various types of storage mechanisms are used to store a XML document. One type of storage mechanism stores a XML document as a text file in a file system.

Another type of mechanism for storing XML documents is a database server. In a database server, a XML document may be stored in a row of a table and nodes of the XML document are stored in separate columns in the row. An entire XML document may also be stored in a lob (large object) in a column. A XML document may also be stored as a hierarchy of objects in a database; each object is an instance of an object class and stores one or more elements of a XML document. The object class defines, for example, the structure corresponding to an element, and includes references or pointers to objects representing the immediate descendants of the element. Tables and/or objects of a database system that hold XML values are referred to herein as base tables or objects.

Need for Structural Information for XML Document Collections

Database servers are being used to store large collections of XML documents. Database servers include many mechanisms that allow for powerful and efficient ways to query large collections of XML documents. Database servers that store XML documents may be enhanced to efficiently perform XML operations using these mechanisms. One such type of XML operation is to execute queries over collections of XML documents using XML query languages, such as XQuery/XPath. XML Query Language (“XQuery”) and XML Path Language (“XPath”) are important standards for a query language, which can be used in conjunction with SQL to express a large variety of useful queries. XPath is described in XML Path Language (Xpath), version 1.0 (W3C Recommendation 16 Nov. 1999), which is incorporated herein by reference.

To write queries more intelligently, it is useful to know the structural information of the collection of XML documents to query. For example, an XPath query identifying an element Address may be written as ‘//Address’. The XPath query requests an element named ‘Address’ that is a descendant of any node in a XML document. However, knowing that Address is a child element of Person allows one to the write the more efficiently evaluated XPath query ‘/Person/Address’, which identifies ‘Address’ as a child element ‘Person’.

Also, structural information about a collection of XML documents is useful to automated query optimization performed by a database server.

Often, information about the structure of a collection of XML documents is not known or is not readily available. Consequently, information useful for writing more efficiently executed queries or automatically optimizing queries is not available.

Based on the foregoing, there is a clear need to develop approaches for generating structural information about a collection of XML documents.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram of a table that stores hierarchical information about a collection of XML documents according to an embodiment of the present invention.

FIG. 2 is a flow chart that provides an overview of a procedure for generating a structural summary of a collection of XML documents according to an embodiment of the present invention.

FIG. 3 is a diagram showing a query and procedure used to generate a XML structural summary according to an embodiment of the present invention.

FIG. 4 is a diagram of a list of ordered pathids and XML structural summary generated from the list according to an embodiment of the present invention.

FIG. 5 is a block diagram of a computer system that may used to implement an embodiment of the present invention.

### DETAILED DESCRIPTION OF THE INVENTION

A method and apparatus for presenting structural information about XML documents is described. In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

Described herein are approaches to generating information about the structure of a collection of XML documents. The approaches are based on the generation of a “structural summary” of a XML document collection. The structural summary is a skeleton tree that represents all parent-child relationships found in a XML document collection. Specifically, a XML document collection is an empty XML document (i.e. document with nodes but no node values) such that if a node N1 is a child of node N2 in any document of the collection, then there is an empty node N1 as a child of node N2 in the structural summary. An empty node is one without a value.

Finally, the structural summary is minimal in that it contains a parent P of child C only if there is at least one document that contains a node C as a child of P. If there are two or more nodes C as a child of node P (i.e. two or more nodes with the same name that are a child of node P), then the structural summary contains only one node C as a child of node P. Furthermore, in an embodiment, a structural summary contains only nodes for elements and attributes, not such nodes as comment nodes.

The following documents D1 and D2 and their structural summary S are provided as an illustration:

```
Document D1
<r>
  <a>123</a>
  <b>foo</b>
  <a>34</a>
</r>
Document D2
<r>
  <b>bar</b>
  <sub>
    <a>345</a>
  </sub>
  <b>foo</b>
</r>
Summary S
<r>
  <a/>
  <b/>
  <sub>
    <a/>
  </sub>
</r>
```

The structural summary of a collection of XML documents is useful in many scenarios. A structural summary provides a condensed summary that can be comprehended quickly and easily by a user. Structural summaries can help users to more intelligently formulate queries, ones that identify valid paths or that can be executed more efficiently.

Structural summaries enable an intuitive mechanism for users to browse the collection. For example, a graphical user interface (GUI) can be built to navigate the document collection in a hierarchical fashion.

Structural summaries may be used by a database server to facilitate the validation of XPath queries and optimize their execution. For example, a database server can use structural summary S to quickly validate whether an XPath expression specifies a valid and existing path in a collection. Whether the path expression ‘/a/b/z’ exists in either XML documents D1 and D2 can be quickly determined from examining structural summary S.

To optimize evaluation of an XPath query, the structural summaries can be used by a database server to automatically rewrite a XPath expression. For example, the XPath query ‘//Address’ is issued by a user to a database server. By exploiting structural information from a structural summary, the database can be automatically rewritten and expanded by the database server to ‘/Person/Address’. Similar optimizations can be applied to expand wildcards.

Finally, a database server can examine a structural summary to determine statistical information useful to optimization. For example, the structural summary can be examined to determine how deep or how broad the hierarchy of a XML document is.

Database Server Implementation

According to embodiment, a structural summary of a XML document collection is generated from an index of a collection of documents. The index resides in a database and is maintained by a database server that manages the database.

The database server stores a collection of XML documents in the database. An entire XML document may be stored in a lob (large object) in a column of a row of a ‘base table’. Alternatively, each XML document in the collection may be stored in a row of a base table and each node of the XML document is stored in a separate column in a row of the base table. More than one base table may be used to store a XML document. Finally, a XML document may also be stored as a hierarchy of objects in a database.

The database server maintains a “logical index” that indexes the collection of XML documents. A logical index contains multiple structures that are cooperatively used to access another body of data, such as a set of one or more XML documents. According to an embodiment of the present invention, a logical index includes a path table, which contains information about the hierarchy of nodes in a collection XML documents and may contain the value of the nodes. The logical index may include other indexes, including ordered indexes. An ordered index contains entries that have been ordered based on an index key.

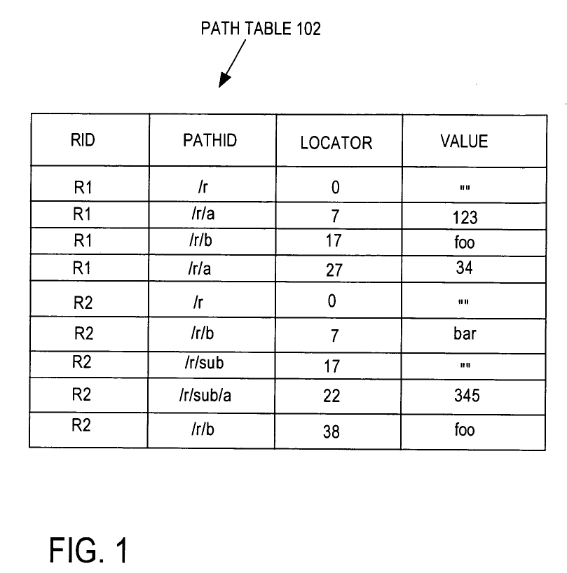

FIG. 1 shows path table 102 of a logical index according to an embodiment. A path table contains hierarchical information about a collection of a set of XML documents. Path table 102 is illustrated with reference to documents D1 and D2.

Path table 102 includes columns RID, PATHID, LOCATOR, and VALUE. Rows in path table 102 each correspond to a node in a collection of XML documents that include documents D1 and D2. Column RID includes row-ids of rows. For the node of a particular row in path table 102, the row-id identifies the row in the base table that stores the node. The first four entries of path table 102 identify row R1, which holds the nodes of document D1 in a LOB column. The next five entries of path table 102 identify row R2, which holds the nodes of document D2.

Column PATHID holds pathids. A pathid is a path expression that represents the “path” within a XML document from a node to another node. The “path” for a node in a XML document reflects a series of parent-child links, starting from a node in a XML document to arrive at a particular node further down in the hierarchy. For example, the path from the root of XML document D1 to node b is ‘/r/b’.

Path expressions can be strings representing a concatenation of names of nodes in a path. However, the names of nodes can be very long. To reduce the length of a path expression, and lessen the amount of storage needed to store the path expression, pathids may be used in lieu of name-based path expressions.

A pathid is comprised of node-id codes that are used in lieu of node names. In a pathid, there is a node-id code for each corresponding node name of a name-based path expression. For example, node-id codes 12 and 23 are assigned to nodes r and b. The path expression based on node-id codes for the path ‘/r/b’ is thus ‘/12/23’. For purposes of exposition, pathids are represented, hereafter and in the figures, as their corresponding name based path expression.

Column LOCATOR contains node locators, which are values indicating the location of a node within a data representation of a XML document. For example, for a stream of text representing a XML document, a node locator may be a value that represents the beginning byte position, within the stream of text, of the text representing the node. As another example, a set of related objects may represent the nodes of a XML document. A node locator may be a reference to the object that represents the node.

Column VALUE contains the values of nodes. Alternatively, a path table may omit a column that holds values of nodes. The values can be obtained by retrieving them from the location identified by a node locator.

Generating XML Structure Based on a Path Table

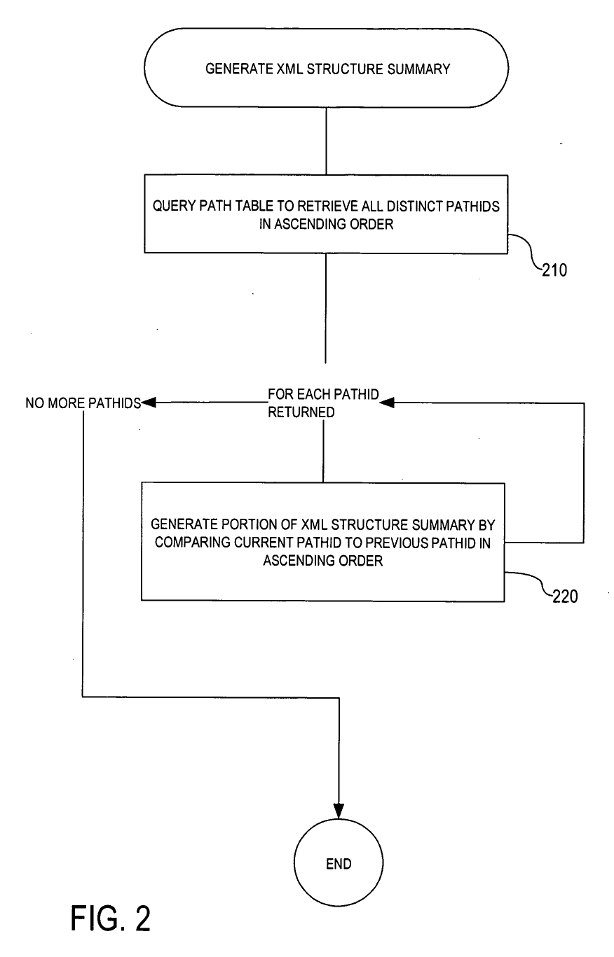

According to an embodiment of the present invention, information in the path table is used to generate a XML structure summary. FIG. 2 shows an overview of a procedure for generating a structure summary in this way according to an embodiment.

Referring to FIG. 2, a path table is queried to retrieve all distinct pathids in ascending order (step 210). For each pathid returned for the query, a portion of the XML structure summary is generated by comparing the current pathid to the previous pathid in the ascending order, on a path component by path component basis (step 220).

A path component is the concatenated component in a path expression that corresponds to a particular node. For example, in the path expression ‘/a/b’, ‘a’ and ‘b’ are path components. In the pathid ‘/12/23’, ‘12’ and ‘13’ are path components.

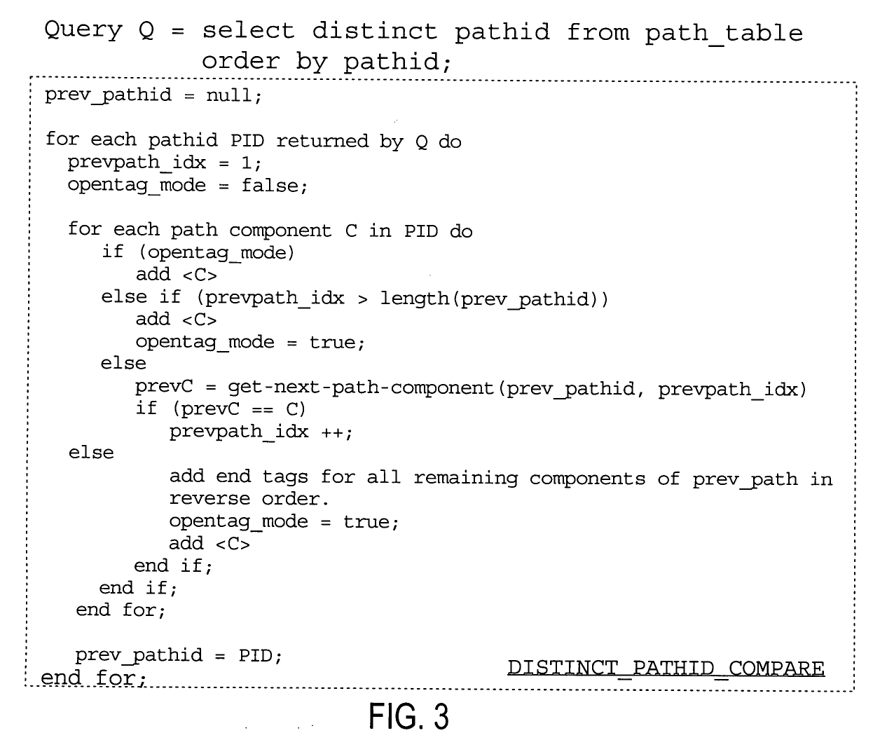

FIG. 3 is a diagram showing an illustrative query Q and procedure DISTINCT_PATHID_COMPARE that may be used to generate structural summaries. Query Q may be issued against a path table to generate a list of distinct pathids in ascending order. The query is issued against table path_table. Table path_table contains a column path_id, which contains pathids. Procedure DISTINCT_PATHID_COMPARE generates a XML structural summary by comparing the list of distinct pathids in ascending order.

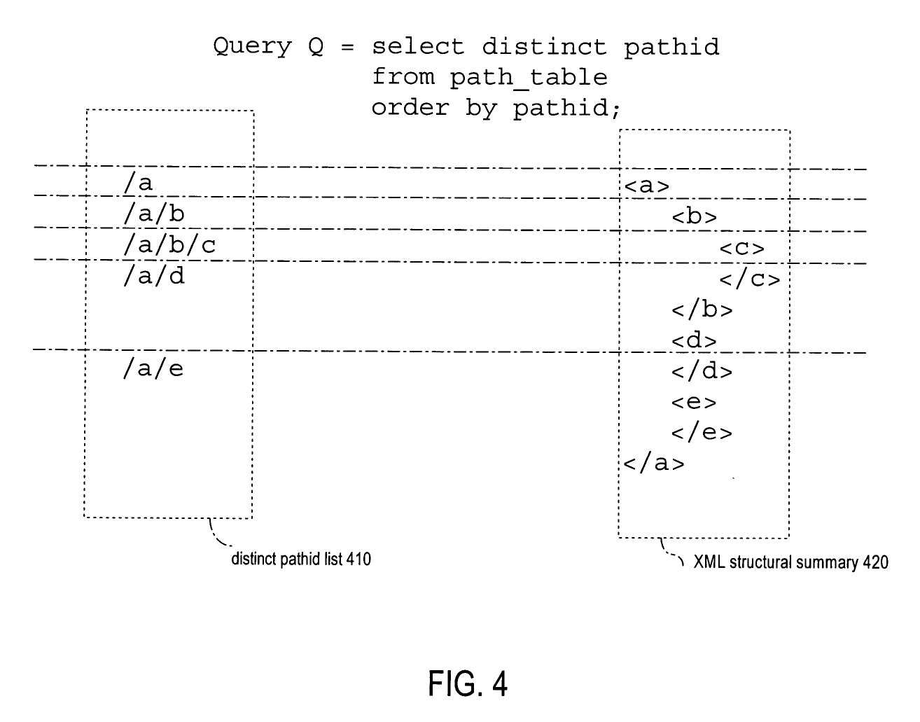

FIG. 4 shows an illustrative distinct pathid list 410, a list of illustrative distinct pathids returned by query Q. Distinct pathid list 410 is used to generate XML structural summary 420. XML structural summary 420 is generated using the procedure DISTINCT_PATHID_COMPARE. Each pathid in distinct pathid list 410 is delimited by lines into sections. Each section contains the portion of XML structural summary 420 generated for the respective pathid as DISTINCT_PATHID_COMPARE processes distinct pathid list 410.

In general, each pathid in XML structural summary 420 introduces a new path component relative to the previous pathid, if any. Procedure DISTINCT_PATHID_COMPARE determines the introduced path component by comparing each path component in the current pathid to the corresponding path component at the same level in the previous pathid. In one case the new path component introduced may be a path component for a level for which there is no path component at the same level in the previous pathid (e.g. the previous and current pathids are ‘/a/b’ and ‘/a/b/c’, where ‘c’ is the introduce path component). In another case, there may be a different path component in the previous pathid at the same level of the introduced path component, with possible other components at lower levels (e.g. the previous and current pathids are ‘/a/b/d/e’ and ‘/a/f’, where ‘f’ is the introduced path component). In either case, an open tag is added to XML structural summary 420 for the path component introduced by the current pathid. In the latter case, one or more terminating tags are added to XML structural summary 420 for the remaining other path components at the lower levels and for the unmatched path component of the previous pathid.

The following is a general illustration of the application of the procedure DISTINCT_PATHID_COMPARE to distinct pathid list 410 to generate XML structural summary 420.

Referring to FIG. 4, when pathid ‘/a’ is the current pathid from distinct pathid list 410, DISTINCT_PATHID_COMPARE determines that there is no previous pathid. Hence, the first level component is introduced by current pathid and a corresponding open tag <a> is created in XML structural summary 420.

For current pathid ‘a/b’, DISTINCT_PATHID_COMPARE determines that the second level path component is different than that of previous pathid ‘/a’, which has no second level component. Hence, the second level component ‘b’ is introduced by the current pathid and a corresponding open tag <b> is created in XML structural summary 420.

Similarly, for current pathid ‘a/b/c’, the third level component ‘c’ is introduced by the current pathid and a corresponding open tag <c> is created in XML structural summary 420.

For current pathid ‘a/d’, a component by component comparison determines that second level path component ‘d’ is different than that of corresponding path component ‘b’ in previous pathid ‘/a/b/c’. Hence, a second level component is introduced by the current pathid. Previous pathid ‘/a/b/c’ has both a second and a third level component. Terminating tags are added for level of the introduced component and the remaining levels below, in reverse order of these levels. Hence terminating tags </c> and then </b> are created in XML structural summary 420. Next, new tag <d> is created for the path component introduced in the current pathid ‘a/d’.

For current pathid ‘a/e’, a component by component comparison determines that the second level component ‘e’ is the path component introduced by current pathid and this it is different then corresponding component ‘d’ in the previous pathid ‘a/d’. Hence, terminating tag </d> is added to XML structural summary 420 and new open tag <e> is created in XML structural summary 420.

Materializing XML Structural Summary

The procedure DISTINCT_PATHID_COMPARE may be invoked on demand to create XML structural summaries. Generating the summaries in this way requires no extra storage or processing steps when Data Manipulation Language (“DML”) operations (e.g. insert, update, upsert) are performed to a path table to add new entries. However, to provide a structural summary, the path table needs to be queried to compute the structural summary.

In an embodiment, a XML structural summary is materialized. That is, a table (“structural-summary table”) is used to store the XML structural summary. A XML structural summary is generated for a path table using, for example, procedure DISTINCT_PATHID_COMPARE, and then stored in the structural-summary table. Once materialized in this way, the structural-summary table is changed to reflect changes made to the path table when XML documents are added to a collection of XML documents.

When a row is inserted into a path table, a determination is of whether the pathid of the row introduced a new pathid into the path table. If so, then the structural-summary is modified to reflect the new pathid. When a row is deleted from the path table, a determination is made of whether any other row has the pathid. If not, then the structural-summary table is modified to reflect the absence of the pathid.

Materializing a structural-summary avoids the need to process a query any time access to it desired. However, it also requires overhead when adding XML documents to a collection maintained by a database server.

Hardware Overview

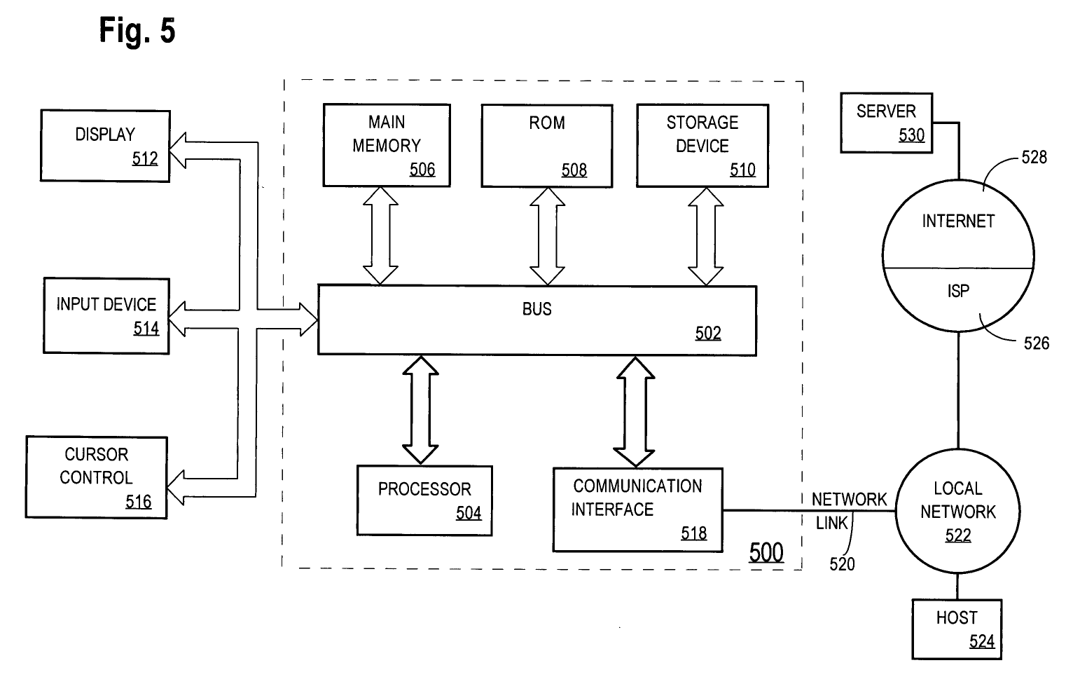

FIG. 5 is a block diagram that illustrates a computer system 500 upon which an embodiment of the invention may be implemented. Computer system 500 includes a bus 502 or other communication mechanism for communicating information, and a processor 504 coupled with bus 502 for processing information. Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Computer system 500 further includes a read only memory (ROM) 508 or other static storage device coupled to bus 502 for storing static information and instructions for processor 504. A storage device 510, such as a magnetic disk or optical disk, is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

The invention is related to the use of computer system 500 for implementing the techniques described herein. According to one embodiment of the invention, those techniques are performed by computer system 500 in response to processor 504 executing one or more sequences of one or more instructions contained in main memory 506. Such instructions may be read into main memory 506 from another computer-readable medium, such as storage device 510. Execution of the sequences of instructions contained in main memory 506 causes processor 504 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 504 for execution. Such a medium may take many forms, including but not limited to, non-volatile media, volatile media, and transmission media. Non-volatile media includes, for example, optical or magnetic disks, such as storage device 510. Volatile media includes dynamic memory, such as main memory 506. Transmission media includes coaxial cables, copper wire and fiber optics, including the wires that comprise bus 502. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 504 for execution. For example, the instructions may initially be carried on a magnetic disk of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are exemplary forms of carrier waves transporting the information.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution. In this manner, computer system 500 may obtain application code in the form of a carrier wave.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method for generating structural information about XML data, the method comprising the steps of:
generating a structural summary that summarizes the structure of a collection of XML documents;
wherein the collection of XML documents includes a hierarchy of nodes, and within said hierarchy a subset of nodes that each have a value;
wherein generating a structural summary includes generating:
a first set of nodes that represent the subset but that have no values,
a parent-child relationship for every parent-child relationship in the collection of XML documents, and
no more than one parent-child relationship for every parent that is in the XML document and that has two more child nodes with the same name.

2. The method of claim 1, wherein:
a path is associated with each node of said hierarchy of nodes;
generating a structural summary includes:
generating an ordered list of distinct path expressions corresponding to the paths associated with said hierarchy of nodes, and
generating a portion of a summary structure by comparing a given path expression of said ordered list to a previous path expression based on the order of said ordered list.

3. The method of claim 2, wherein:
a column of a table contains said path expressions; and
generating an ordered list of distinct path expressions includes querying table for distinct values from said column.

4. The method of claim 2, wherein generating a portion of the summary structure by comparing includes:
determining that the given path expression introduces a certain path component not matched by a path component at the same level in the previous path expression; and
generating an open tag representing a node corresponding to said certain path component.

5. The method of claim 4, wherein:
the previous path expression includes another path component at the same level of the certain path component; and
generating a portion of the summary structure by comparing includes:
generating a terminating tag for said another path component, and
if said previous path expression includes a path component at a lower level lower than the level of the another path component, generating a terminating tag for a node corresponding to the path component at the lower level.

6. The method of claim 3, wherein said column includes as path expressions pathids.

7. The method of claim 1, wherein a database server manages access to said XML collection and generates said structural summary.

8. The method of claim 7, further including the steps of:
the database server maintaining said structural summary in a table; and
said database server updating said structural summary in response to modifications to said collection of XML documents.

9. The method of claim 7, wherein said database server uses said structural summary to determine how to execute queries of said collection of XML documents.

10. A computer-readable medium carrying one or more sequences of instructions which, when executed by one or more processors, causes the one or more processors to perform the method recited in claim 1.

11. A computer-readable medium carrying one or more sequences of instructions which, when executed by one or more processors, causes the one or more processors to perform the method recited in claim 2.

12. A computer-readable medium carrying one or more sequences of instructions which, when executed by one or more processors, causes the one or more processors to perform the method recited in claim 3.

13. A computer-readable medium carrying one or more sequences of instructions which, when executed by one or more processors, causes the one or more processors to perform the method recited in claim 4.

14. A computer-readable medium carrying one or more sequences of instructions which, when executed by one or more processors, causes the one or more processors to perform the method recited in claim 5.

15. A computer-readable medium carrying one or more sequences of instructions which, when executed by one or more processors, causes the one or more processors to perform the method recited in claim 6.

16. A computer-readable medium carrying one or more sequences of instructions which, when executed by one or more processors, causes the one or more processors to perform the method recited in claim 7.

17. A computer-readable medium carrying one or more sequences of instructions which, when executed by one or more processors, causes the one or more processors to perform the method recited in claim 8.

18. A computer-readable medium carrying one or more sequences of instructions which, when executed by one or more processors, causes the one or more processors to perform the method recited in claim 9.
